(19) United States
(12) Patent Application Publication
(10) Pub. No.: US 2020/0013092 A1
(43) Pub. Date: Jan. 9, 2020

(54) Message Generation for Ranked Users Based on User Interaction Probabilities

(71) Applicant: International Business Machines Corporation, Armonk, NY (US)

(72) Inventors: Zhe Liu, San Jose, CA (US); Mengdi Zhang, San Jose, CA (US); Anbang Xu, San Jose, CA (US); April L. Webster, Mountain View, CA (US); Jalal U. Mahmud, San Jose, CA (US); Thomas G. Zimmerman, Cupertino, CA (US); Rama Kalyani T. Akkiraju, Cupertino, CA (US); Vibha S. Sinha, Santa Clara, CA (US)

(21) Appl. No.: 16/028,533

(22) Filed: Jul. 6, 2018

(51) Int. Cl. G06Q 30/02; G06Q 50/00; G06N 7/00

(52) U.S. Cl. CPC G06Q 30/0271; G06N 7/005; G06Q 50/01

(57) ABSTRACT

An approach is provided in which a system determines a set of message properties corresponding to a set of products based on product data analysis. The system then identifies a set of user properties of users based on analyzing social media data corresponding to the product data. Next, the system identifies a set of candidate customers from the set of users based on analyzing the set of user properties against the set of product data. In turn, the system generates a set of target messages that are tailored to a combination of candidate customer properties corresponding to the set of candidate customers and the product data.

### BACKGROUND

Personalized marketing, or one-to-one marketing, is a marketing strategy by which companies leverage data analysis and digital technology to deliver individualized messages and product offerings to current or prospective customers. Advancements in data collection methods, analytics, digital electronics, and digital economics have enabled marketers to deploy more effective real-time and prolonged customer experience personalization tactics.

Businesses may evaluate personal profiles of candidate customers when delivering individualized messages. However, the personality traits in the personal profile are not evaluated or matched against the actual aim of a marketing campaign and/or a brand's image (sophisticated, youthful, etc.). Similar to a candidate customer's personality, a brand's personality is both enduring and distinctive and should not be discounted when generating individualized messages to candidate customers.

### BRIEF SUMMARY

According to one embodiment of the present disclosure, an approach is provided in which a system determines a set of message properties corresponding to a set of products based on product data analysis. The system then identifies a set of user properties of users based on analyzing social media data corresponding to the product data. Next, the system identifies a set of candidate customers from the set of users based on analyzing the set of user properties against the set of product data. In turn, the system generates a set of target messages that are tailored to a combination of candidate customer properties corresponding to the set of candidate customers and the product data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram showing a personality-matched message generator generating target messages based on analyzing user personalities against brand personalities;

FIG. 4 is an exemplary diagram depicting a candidate customer selector generator generating a customer-message interaction matrix based on brand data, user interaction data, and advertising activities;

FIG. 5 is an exemplary diagram depicting analysis of a user message interaction matrix to identify a set of candidate customers;

FIG. 6 is a flowchart showing steps taken to identify candidate customers most likely to prefer messages of a certain type; and

FIG. 7 is an exemplary flowchart showing steps taken to generate sample messages and select target messages based on brand personalities and user personalities.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-selling data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

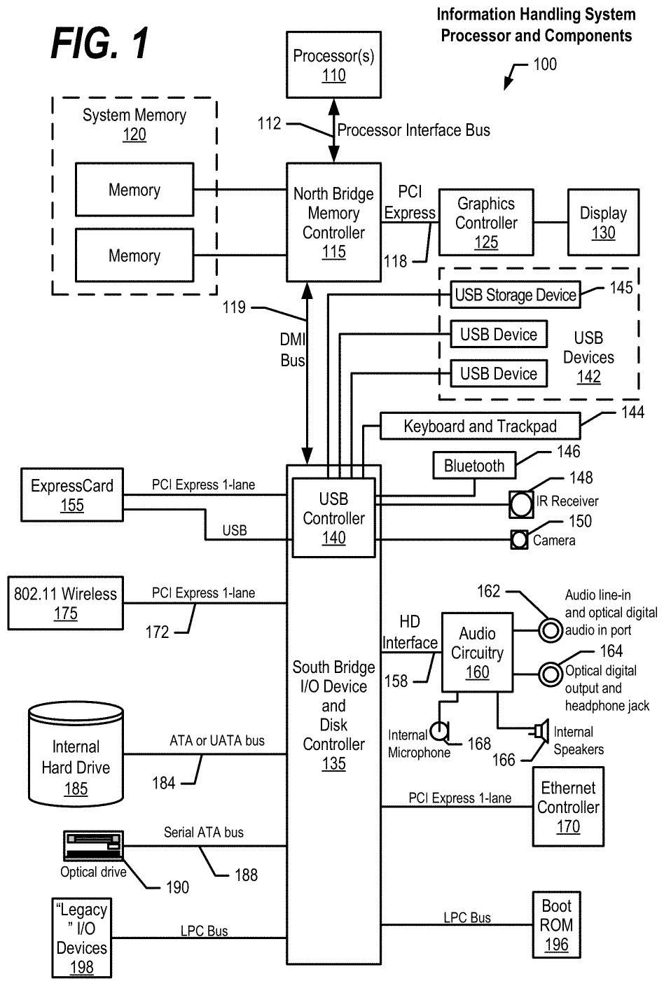

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119, In some embodiments, the bus is a Direct Media interface (DMI) bus that transfers data at high speeds in each direction between Northbridge 116 and Southbridge 135, In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

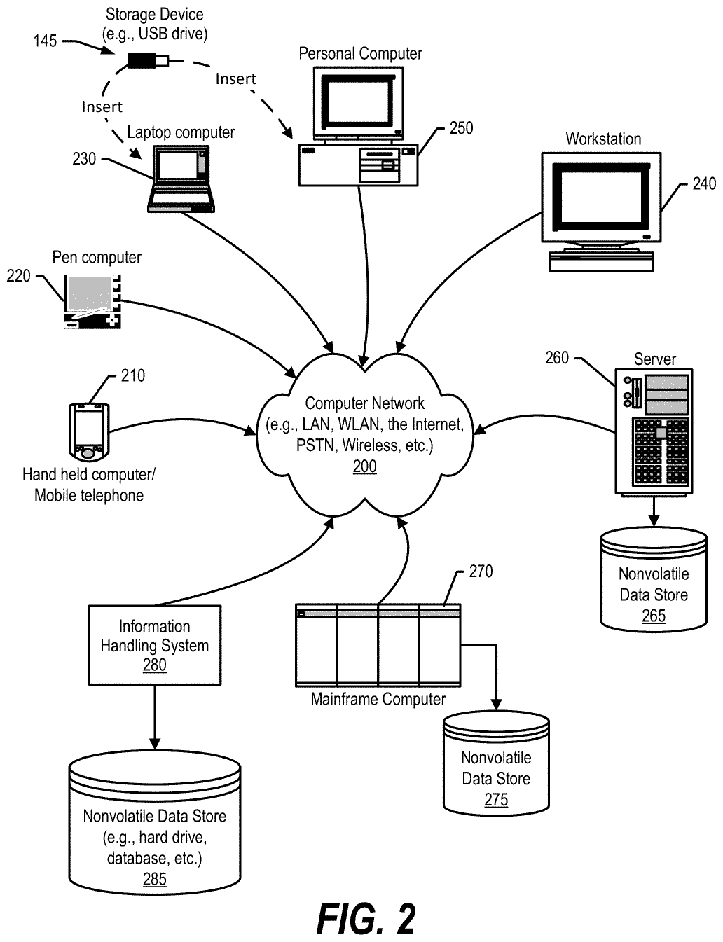

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

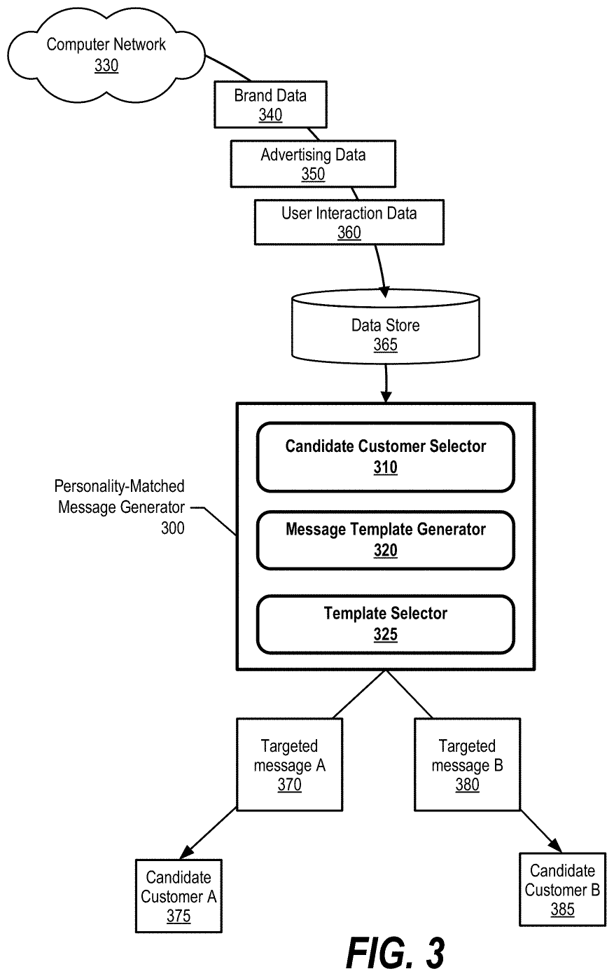

FIGS. 3 through 7 depict an approach that can be executed on an information handling system to match customer personalities with brand personalities and create a personalized marketing ad within the spirit of a brand. The approach discussed herein includes advantages over prior systems such as, for example, integrating the customer's personality with the brand's personality for target message selection. In addition, the approach discussed herein optimizes the tradeoff between customer personality and brand personality to generate effective messages that make candidate customers feel important while maintaining the uniqueness of the brand.

In one embodiment, the information handling system provides marketers with the best candidate wording to better tailor the marketer's campaign message according to the candidate customer's personality and the brand personality. In another embodiment, the target messages are target advertisements.

FIG. 3 is an exemplary diagram showing a personality-matched message generator generating target messages based on analyzing user personalities against brand personalities. Personality-matched message generator 300 integrates individual personality, brand personality, and message type together to recommend target messages to candidate customers. In one embodiment, personality-matched message generator 300 considers possible contradictions between user personalities and brand personalities, and quantifies the tradeoff between personalization and consistency.

Personality-matched message generator 300 stores, in data store 365, brand data 340, advertising data 350, and user interaction data 360, which is retrieved from computer network 330. The data may be retrieved, for example, by crawling social media messages exchanged between business accounts and individual accounts.

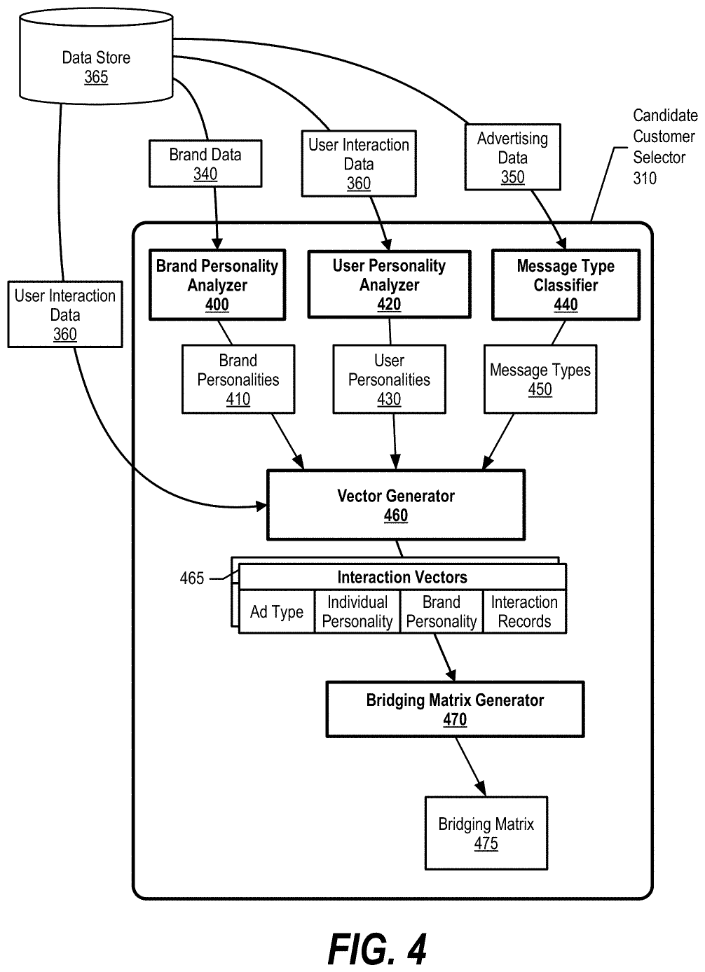

Personality-matched message generator 300 includes candidate customer selector 310, message template generator 320, and template selector 325. Candidate customer selector 310 selects the top “m” candidate customers that would be interested in a perspective message (see FIGS. 4, 5, 6, and corresponding text for further details).

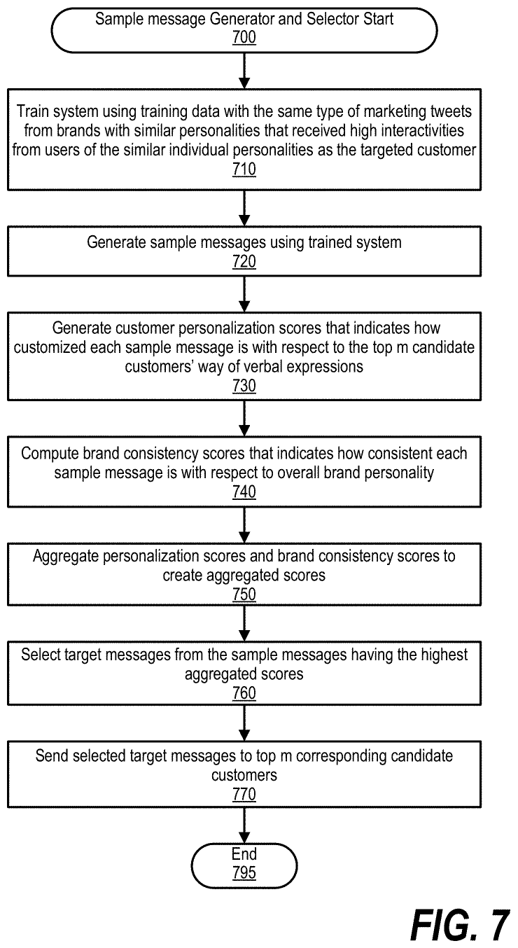

Message template generator 320 generates sample messages and may be implemented using template-based or off-the-shelf deep learning techniques, such as RNN (recurrent neural network), LSTM (long-short term memory), Variational Autoencoder (VAE), and GAN (generative adversarial network). In one embodiment, training data for the deep learning models may be the same type of social media data from brands with similar personalities that received high interactivities from users of the similar individual personalities as the candidate customers (see FIG. 7 and corresponding text for further details).

Template selector 325 identifies the top n candidate templates generated from message template generator 320 to evaluate and rank for the best fitted template for a specific customer, as well as the purpose of the campaign. Template selector 325 takes two measurements in terms of evaluating the effectiveness and appropriateness of the message. The first measurement is a “personalization score” that indicates how customized the sample message text is with respect to the candidate customer's way of verbal expression. The personalization score is measured by the similarity between the particular text and the candidate customer's own posts on social media. The second measurement is a “consistency score” that indicates how consistent the sample message text is with respect to the overall brand personality. This is calculated as the similarity between the brand personality derived from this sample message text and the previously defined brand personality.

Personality-matched message generator 300 then optimizes the trade-off between the personalization score and the consistency score by selecting the candidate text with the highest aggregated score (see FIG. 7 and corresponding text for further details). In turn, personality-matched message generator 300 sends targeted message A 370 to candidate customer A 375, and sends a different targeted message B 380 to candidate customer B 385.

FIG. 4 is an exemplary diagram depicting a candidate customer selector selecting candidate customers based on brand data, user interaction data, and advertising data. Candidate customer selector 310 includes brand personality analyzer 400, user personality analyzer 420, and message type classifier 440. Brand personality analyzer 400 receives brand data 340 corresponding to products and computationally assesses the personality of the brand that, in one embodiment, identifies major dimensions and sub-traits of the brand (brand personalities 410).

User personality analyzer 420 receives user interaction data 360 and calculates personalities of candidate customers that, in one embodiment, identifies major dimensions and facets of the candidate customers (user personalities 430).

Message type classifier 440 receives advertising data 350 corresponding to current messages and classifies the current messages into types, such as a relationship maintenance message type, a new product release message type, a customer engagement enhancement message type, and a promotion/sales message type (message types 450).

Vector generator 460 receives brand personalities 410, user personalities 430, message types 450, and user interaction data 360 to create interaction vectors 465. Each of interaction vectors 465 corresponds to one the user interactions in user interaction data 360 and includes the type of the message that was interacted, the personality of the corresponding interacting user (from user personalities 430), the brand personality of the corresponding brand (from brand personalities 410), and the user's corresponding interaction records which denotes his/her preference regarding the message.

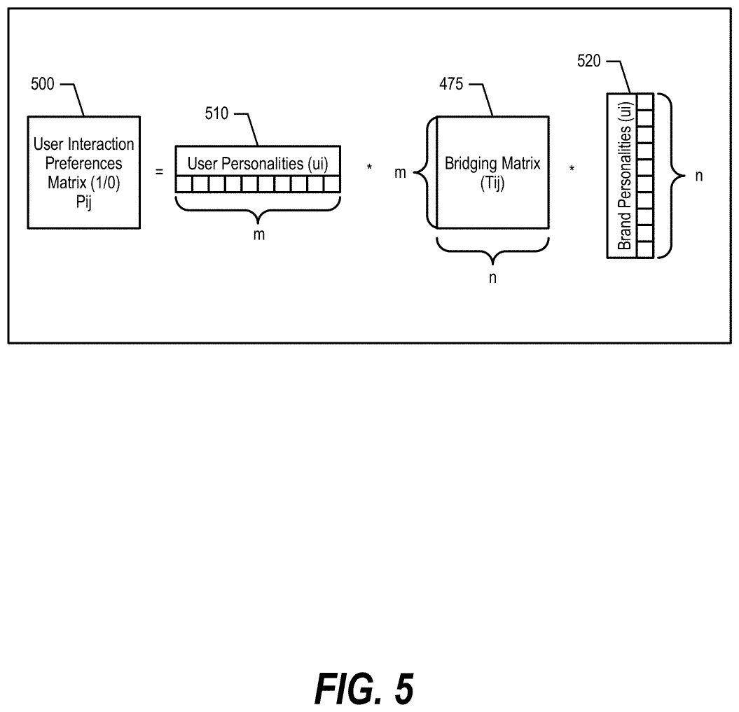

For each specific type of message, bridging matrix generator 470 treats the interaction behavior as a product of three factors, namely brand personality B, individual personality U, and a bridging matrix T. Bridging matrix generator 470 uses information in interaction vectors 465 to identify user interaction preferences, user personalities, and brand personalities to generate bridging matrix 475, which includes various weighting factors as discussed in more detail below (see FIG. 5 and corresponding text for further details). In turn, bridging matrix 475 may be utilized to predict which users will prefer certain messages given a new user ui and a target brand Bj.

FIG. 5 is an exemplary diagram depicting information used form interaction vectors 465 to generate a bridging matrix. In one embodiment, to determine a bridging matrix “T” where Pᵢⱼ˜Uₗ T Bⱼ, candidate customer selector 310 defines a cost function as:

$$arg {min}_{T} {\{ \frac{1}{2 \vert P \vert} {\sum }_{{r}_{ij} ∈ R} ( {p}_{ij} - {u}_{i} {Tb}_{j} ) )}^{2} + \frac{λ}{2} {‖ T ‖}^{2} \}$$

where pij is the interaction preference of the ith users with regard to the jth brand, ui is the ith user's individual personality, bj is the jth brand's brand personality. λ is a regularization parameter to avoid overfitting. For example, assume there are four users (uA, uB, uC, uD) and three brands (b1, b2, b3) with user interaction histories. Assuming that user A has “liked” the “new product release” messages of brand 1 and 2. User B has liked the “new product release” of brand 3. User c has liked the “new product release” of all three brands. And, user D has no interaction with any message from any brand. The resultant user interaction preferences matrix P (500) is:

$$P = \{ \begin{matrix}1 & 0 & 0 \\ 0 & 1 & 0 \\ 0 & 0 & 1 \\ 0 & 0 & 0\end{matrix} \}$$

Rows in P 500 represent users and columns in P 500 represent brands. Assuming the embodiment with five basic dimensions of user personality and five basic dimensions of brand personality, a user's personality matrix U (510) and brand personality matrix B (520), U and B may be:

$$U = \{ \begin{matrix}0.94 & 0.81 & 0.65 & 0.45 & 0.3 \\ 0.16 & 0.98 & 0.12 & 0.74 & 0.45 \\ 0.77 & 0.90 & 0.76 & 0.25 & 0.67 \\ 0.56 & 0.12 & 0.34 & 0.49 & 0.94 \\ 0.15 & 0.94 & 0.78 & 0.67 & 0.42\end{matrix} \}$$

$$B = \{ \begin{matrix}0.12 & 0.53 & 0.95 & 0.24 & 0.78 \\ 0.58 & 0.21 & 0.17 & 0.71 & 0.51 \\ 0.16 & 0.74 & 0.82 & 0.91 & 0.25\end{matrix} \}$$

Given P, U and B, bridging matrix generator 470 “learns” the bridging matrix T 475 that enables: Pᵢⱼ=UᵢTBⱼ. Once T is learned, given a new user E and a brand 4, personality-matched message generator 300 is able to calculate P_{E4}, given U_{E} and B₄ provided from user personality analyzer 420 and brand personality analyzer 400. Based on the calculated preference Pₗ₄ for each individual regarding the specific brand 4, personality-matched message generator 300 can generate a ranked list of users who have high probability of liking brand 4's messages on “new product release.”

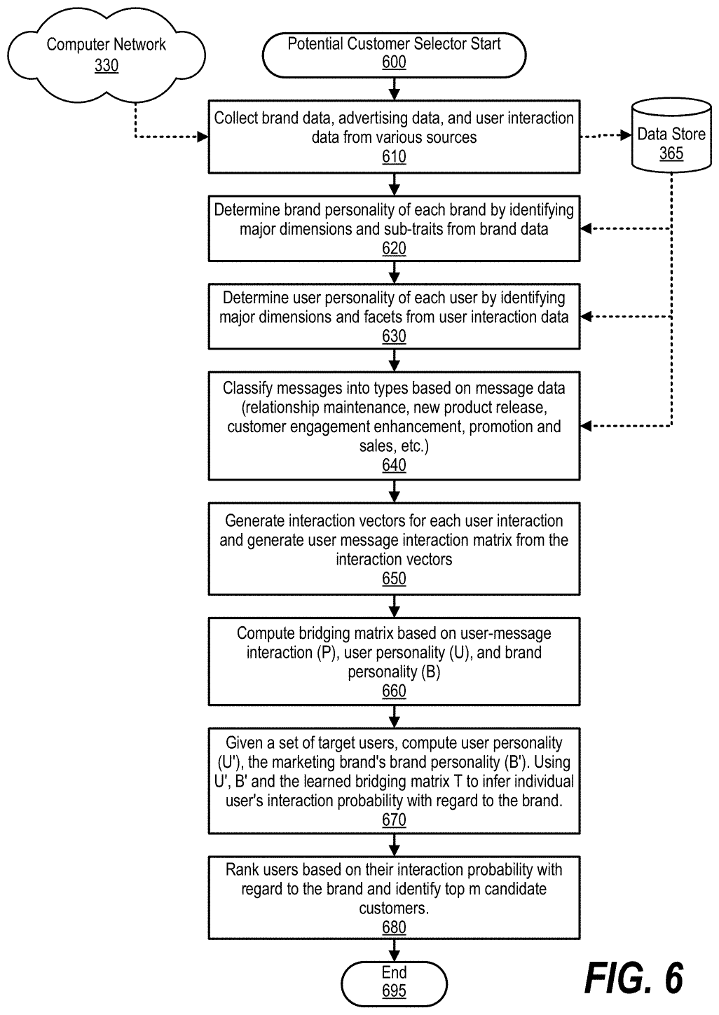

FIG. 6 is a flowchart showing steps taken to identify candidate customers most likely to prefer messages of a certain type. As discussed herein, personality-matched message generator 300 identifies a set of users who potentially would have high interests in a company's message of certain type (relationship maintenance, new product release, customer engagement enhancement, and promotion and sales). Then, with this target list, personality-matched message generator 300 generates target messages that are sent to the candidate customers (see FIG. 7 and corresponding text for further details).

FIG. 6 processing commences at 600 whereupon, at step 610, the process collects brand data, advertising activities, and user interaction data from various sources. At step 620, the process determines a brand personality of each brand by identifying major dimensions and sub-traits from brand data. For example, step 620 may predict a score of 0.98 for brand 4's brand “Competence”, which means brand 4 is among the 2% most “competitive” brands compared with other brands. Step 620 may also provide a number of more detailed sub-traits for brand 4 under “Competence”, such as its “reliability”, its “intelligence”, “leadership”, and “confidence”, etc. Similarly, step 620 provides a score for each of the sub-traits.

At step 630, the process determines a user personality of each user by identifying major dimensions and facets from user interaction data. For example, step 630 may predict a score of 0.23 for user E's “Extroversion”. More detailed sub-traits under “Extroversion” may include dimensions, such as “Cheerfulness”, “Assertiveness”, “Warmth”, “Excitement-seeking”, etc. Each of the sub-traits are assigned a score calculated at step 630.

At step 640, the process classifies messages into types based on message activities. For example, the process may classify the messages into types such as a relationship maintenance message type, a new product release message type, a customer engagement enhancement message type, or a promotion/sales message type.

At step 650, the process generates a matrix of customer-message interaction records based on brand personalities, user personalities, message types, and user interactions). At step 660, the process computes a bridging matrix by minimizing the quadratic difference between real interaction preference and predicted interaction preference (see FIG. 5 and corresponding text for further details.

At step 670, the process computes user personalities (U′) of a given set of target users with the help of step 420, and the brand personality (B′) with the help of step 400. Given the bridging matrix T learnt at step 660, step 670 can infer the user preference probabilities P=B′ T U′.

At step 680, the process ranks users based on their interaction probability and, from the ranking, selects the top m candidate customers for further analysis in FIG. 7. For example, suppose a brand identifies 100,000 potential customers on a social media site for their message campaign on new product release. Step 660 assists the brand manager to determine which subset of users to target to have more personalized interactions by inferring the interaction preference probability based on each potential user's individual's personality, brand's personality, and the learned bridging matrix. FIG. 6 processing thereafter ends at 695.

FIG. 7 is an exemplary flowchart showing steps taken to generate sample messages and select target messages based on brand personalities and user personalities. FIG. 7 processing commences at 700 whereupon, at step 710, the process trains personality-matched message generator 300 using training data with the same type, but different social media data from brands with similar personalities that received high interactivities from users of the similar individual personalities as the targeted customer.

At step 720, the process generates sample messages using the template based or deep learning based approaches (e.g. RNN, LSTM, VAE, GAN), etc. At step 730, the process generates customer personalization scores that indicates how customized the sample message text is with respect to the top m candidate customers' (from FIG. 6) way of verbal expressions. For example, every generated message is aligned with each potential user's previous messages, and a similarity score is calculated using techniques such as with a language model or a pre-trained classifier. The goal of step 730 is to rank the more personalized message template higher and to ensure the message matches the potential user's personality.

At step 740, the process computes a brand consistency score that indicates how consistent the sample message text is with respect to overall brand personality. At step 750, the process aggregates the customer personalization scores and brand consistency scores and, at step 760, the process selects target messages from the sample messages having the highest aggregated score based on, for example, a trade-off function defined as:

S=(1−β)Sₚ+βS_{c}

Where Sₚ is the “personalization score”, S_{c} is the “consistency score”, β is the tuning weight learnt from ground truth data of previous successful campaigns or pre-defined by a user (marketer). The text generated and selected by this module will be a favorable balance between individual customization and brand personality consistency. For example, by setting up a tuning weight, step 750 allows the marketers to decide what to do when there is a controversy between the personalization score and the consistency score. If the marketers value more about the brand's image, then they can give more weight to the consistency score and rank the message with higher consistency scores to the top. Otherwise, if they value more about personalization, then they can give more weight to the personalization score and ranks more personalized ads higher.

At step 770, the process sends the selected target messages to the corresponding candidate customers, and FIG. 7 processing thereafter ends at 795.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
determining a set of brand personalities corresponding to a set of products based on analyzing brand data corresponding to the set of products;
identifying a set of user personalities of a set of users based on analyzing social media data corresponding to the set of products generated by the set of users;
identifying a set of candidate customers from the set of users based on analyzing the set of user personalities against the set of brand personalities, wherein the set of candidate customers correspond to a set of candidate customer personalities comprised in the set of user personalities; and
creating a set of target messages wherein each target message is tailored to a combination of one of the candidate customer personalities and one of the brand personalities.

2. The method of claim 1 wherein the social media data comprises a plurality of user interactions written by the set of users and corresponding to a set of current messages, the method further comprising:
assigning a message type to each of the set of current messages, resulting in a set of message types;
creating, for each of the plurality of user interactions, an interaction vector that comprises one of the plurality of user interactions, a corresponding one of the set of message types, a corresponding one of the set of user personalities, and a corresponding one of the set of brand personalities, resulting in a plurality of interaction vectors; and
generating, based on the plurality of interaction vectors, a user interaction preferences matrix, a user personality matrix and a brand personality matrix, wherein the user interaction preferences matrix represents the plurality of user interactions, the user personality matrix represents the set of user personalities, and the brand personality matrix represents the set of brand personalities.

3. The method of claim 2 further comprising:
computing a bridging matrix that indicates a correlation between the user personality matrix and the brand personality matrix relative to the user interaction preferences matrix; and
selecting the set of candidate customers from the set of users based on the bridging matrix.

4. The method of claim 2 wherein the message type is selected from the group consisting of a relationship maintenance message type, a new product release message type, a customer engagement enhancement message type, and a promotion/sales message type.

5. The method of claim 1 further comprising:
training the information handling system using a set of training data comprising different social media data corresponding to a different set of products that are similar to the set of products;
generating a set of sample messages using the trained information handling system; and
generating a set of brand personality scores for each of the sample messages based on comparing the set of sample messages against the set of brand personalities.

6. The method of claim 5 further comprising:
generating a set of customer personalization scores for each of the set of sample messages based on comparing the set of sample messages against a set of verbal expressions comprised in the social media data and written by the set of candidate customers; and
aggregating each one of the set of customer personalization scores with each corresponding one of the set of brand personality scores, resulting in a set of aggregation scores each corresponding to one of the set of sample messages that optimize a tradeoff between the set customer personalization scores and the set of brand personality scores.

7. The method of claim 6 further comprising:
selecting, based on the set of aggregation scores, the et of target messages from the set of sample messages; and
sending the set of target messages to the set of corresponding candidate customers.

8. An information handling system comprising:
one or more processors;
a memory coupled to at least one of the processors;
a set of computer program instructions stored in the memory and executed by at least one of the processors in order to perform actions of:
determining a set of brand personalities corresponding to a set of products based on analyzing brand data corresponding to the set of products;
identifying a set of user personalities of a set of users based on analyzing social media data corresponding to the set of products generated by the set of users;
identifying a set of candidate customers from the set of users based on analyzing the set of user personalities against the set of brand personalities, wherein the set of candidate customers correspond to a set of candidate customer personalities comprised in the set of user personalities; and
creating a set of target messages wherein each target message is tailored to a combination of one of the candidate customer personalities and one of the brand personalities.

9. The information handling system of claim 8 wherein the social media data comprises a plurality of user interactions written by the set of users and corresponding to a set of current messages, and wherein the processors perform additional actions comprising:
assigning an message type to each of the set of current messages, resulting in a set of message types;
creating, for each of the plurality of user interactions, an interaction vector that comprises one of the plurality of user interactions, a corresponding one of the set of message types, a corresponding one of the set of user personalities, and a corresponding one of the set of brand personalities, resulting in a plurality of interaction vectors; and
generating, based on the plurality of interaction vectors, a user interaction preferences matrix, a user personality matrix and a brand personality matrix, wherein the user interaction preferences matrix represents the plurality of user interactions, the user personality matrix represents the set of user personalities, and the brand personality matrix represents the set of brand personalities.

10. The information handling system of claim 9 wherein the processors perform additional actions comprising:
computing a bridging matrix that indicates a correlation between the user personality matrix and the brand personality matrix relative to the user interaction preferences matrix; and
selecting the set of candidate customers from the set of users based on the bridging matrix.

11. The information handling system of claim 9 wherein the message type is selected from the group consisting of a relationship maintenance message type, a new product release message type, a customer engagement enhancement message type, and a promotion/sales message type.

12. The information handling system of claim 8 wherein the processors perform additional actions comprising:
training the information handling system using a set of training data comprising different social media data corresponding to a different set of products that are similar to the set of products;
generating a set of sample messages using the trained information handling system; and
generating a set of brand personality scores for each of the sample messages based on comparing the set of sample messages against the set of brand personalities.

13. The information handling system of claim 12 wherein the processors perform additional actions comprising:
generating a set of customer personalization scores for each of the set of sample messages based on comparing the set of sample messages against a set of verbal expressions comprised in the social media data and written by the set of candidate customers; and
aggregating each one of the set of customer personalization scores with each corresponding one of the set of brand personality scores, resulting in a set of aggregation scores each corresponding to one of the set of sample messages that optimize a tradeoff between the set customer personalization scores and the set of brand personality scores.

14. The information handling system of claim 13 wherein the processors perform additional actions comprising:
selecting, based on the set of aggregation scores, the set of target messages from the set of sample messages; and
sending the set of target messages to the set of corresponding candidate customers.

15. A computer program product stored in a computer readable storage medium, comprising computer program code that, when executed by an information handling system, causes the information handling system to perform actions comprising:
determining a set of brand personalities corresponding to a set of products based on analyzing brand data corresponding to the set of products;
identifying a set of user personalities of a set of users based on analyzing social media data corresponding to the set of products generated by the set of users;
identifying a set of candidate customers from the set of users based on analyzing the set of user personalities against the set of brand personalities, wherein the set of candidate customers correspond to a set of candidate customer personalities comprised in the set of user personalities; and
creating a set of target messages wherein each target message is tailored to a combination of one of the candidate customer personalities and one of the brand personalities.

16. The computer program product of claim 15 wherein the social media data comprises a plurality of user interactions written by the set of users and corresponding to a set of current messages, and wherein the information handling system performs further actions comprising:
assigning an message type to each of the set of current messages, resulting in a set of message types;
creating, for each of the plurality of user interactions, an interaction vector that comprises one of the plurality of user interactions, a corresponding one of the set of message types, a corresponding one of the set of user personalities, and a corresponding one of the set of brand personalities, resulting in a plurality of interaction vectors; and
generating, based on the plurality of interaction vectors, a user interaction preferences matrix, a user personality matrix and a brand personality matrix, wherein the user interaction preferences matrix represents the plurality of user interactions, the user personality matrix represents the set of user personalities, and the brand personality matrix represents the set of brand personalities.

17. The computer program product of claim 16 wherein the information handling system performs further actions comprising:
computing a bridging matrix that indicates a correlation between the user personality matrix and the brand personality matrix relative to the user interaction preferences matrix; and
selecting the set of candidate customers from the set of users based on the bridging matrix.

18. The computer program product of claim 16 wherein the message type is selected from the group consisting of a relationship maintenance message type, a new product release message type, a customer engagement enhancement message type, and a promotion/sales message type.

19. The computer program product of claim 15 wherein the information handling system performs further actions comprising:
training the information handling system using a set of training data comprising different social media data corresponding to a different set of products that are similar to the set of products;
generating a set of sample messages using the trained information handling system; and
generating a set of brand personality scores for each of the sample messages based on comparing the set of sample messages against the set of brand personalities.

20. The computer program product of claim 19 wherein the information handling system performs further actions comprising:
generating a set of customer personalization scores for each of the set of sample messages based on comparing the set of sample messages against a set of verbal expressions comprised in the social media data and written by the set of candidate customers;
aggregating each one of the set of customer personalization scores with each corresponding one of the set of brand personality scores, resulting in a set of aggregation scores each corresponding to one of the set of sample messages that optimize a tradeoff between the set customer personalization scores and the set of brand personality scores;
selecting, based on the set of aggregation scores, the set of target messages from the set of sample messages; and
sending the set of target messages to the set of corresponding candidate customers.
